(19) United States
(12) Patent Application Publication
(10) Pub. No.: US 2009/0140868 A1
(43) Pub. Date: Jun. 4, 2009

(54) Smoke detection method and system

(76) Inventor: David Booth, Tigard, OR (US)

Correspondence Address: IPSOLON LLP, 111 SW COLUMBIA, SUITE 710, PORTLAND, OR, 97201, US

(21) Appl. No.: 11/645,816

(22) Filed: Dec. 26, 2006

Related U.S. Application Data
(60) Provisional application No. 60/755,332, filed on Dec. 29, 2005.

(51) Int. Cl. G08B 17/10

(52) U.S. Cl. 340/628

(57) ABSTRACT

A smoke detection method includes ramp-counting of non-decreasing smoke level samples for detecting smoldering fire conditions and counting of obscuring smoke level samples for detecting other-than-smoldering fire conditions. The ramp-counting of non-decreasing smoke level samples includes increasing a smoke detection ramp count for each successive smoke level sample that does not decrease from a previous one and resetting the smoke detection ramp count whenever a smoke level sample decreases relative to a previous one.

### BACKGROUND OF THE INVENTION

Smoke detectors available to consumers are gravely inadequate to detect the type of fire that poses the greatest threat today: the smoldering fire. The most common, lowest price smoke detection method is “Ionization”. Ion detectors dominate the marketplace with a 90% market share. Unfortunately, ion detectors perform poorly with respect to slowly accumulating smoke and may not sound an alarm until long after smoke or fumes have reached a lethal level.

Ionization performs poorly because it is inherently insensitive to the conditions of a smoldering fire. The slower, cooler conditions of a smoldering fire allow small smoke particles to coalesce with each other to become fewer, larger particles. Because ion detectors generate and depend on millions of moving charges in the air, relatively few, larger particles of smoke are insufficient to affect the ion currents and trigger the alarm.

Ion detectors also perform poorly due to their elaborate wind shielding. Wind moves ions so they can easily trigger an ion-based alarm. Dust build-up also interferes with ionization currents and makes an ion detector less sensitive. As a result, ion detectors have been designed for limited “breathing” in order to reduce false alarms and avoid dust build-up. An optimum design for detecting smoldering smoke would promote, rather than block, air-flow through the device.

Light scattering (LS), the other main smoke detector technology available today, has similar disadvantages. This method measures the amount of light scattering off of smoke particles. LS is an inferior method of detection for smoldering fires because it responds only when light scatters off of smoke particles at a large enough angle to reach a photodiode detector. LS also uses infrared light (wavelength >700 nm) to avoid the influence of signal noise from ambient light. This IR light is only scattered by the largest smoke particles that reach the photodiode.

The color of the smoke also dramatically affects LS detector performance, because the technology is far more sensitive to white smoke than dark smoke. As with the Ion detectors, LS detectors must also employ substantial shielding to block out ambient light and to prevent dust build-up so as to minimize false alarm and signal response changes. Both LS and Ion detectors generally suffer from reduced sensitivity as they age and gather dust. Both technologies also have a large and variable background signal component which must be accurately accounted for over the life of the product.

Consumer lawsuits are drawing attention to the poor performance of the ion and LS technologies in today's smoke detectors. Cases often involve ‘working’ detectors that did not detect a smoldering fire in time. It seems clear that ion detectors especially were designed primarily with flaming fires in mind. Flaming fires produce large amounts of steam and heat, and these are the precise conditions that will trigger an ion-based alarm. The wind and turbulence that drive the smoke and steam into the detector strongly affect the ion flows.

Lethal smoldering fires have a lingering, gradual build up of smoke and fumes made of ever larger particles—almost the opposite of what an ion detector is designed to detect. However, consumers have no choice but to rely on ionization and LS detectors to warn them of smoldering fires, a task for which they are both quite poorly suited.

The growing risk of smoldering fires is well established. Currently, 84% of all fire deaths in the U.S. occur at home. Smoke from smoldering fires in turn causes 75% of all these home deaths. Ironically, the mandated use of non-flammable materials in home building and decorating has exacerbated the smoldering fire risk. The common flaming fires of the past are evolving into the slow building smoky fires that are virtually invisible to ion and LS detectors.

All smoke detectors must provide shielding from common ambient conditions, such as insects, to prevent false alarms. Ion detectors require additional shielding against wind to avoid false alarms and against dust to avoid loss of performance. LS detectors require additional shielding against dust and from ambient light. This shielding blocks slowly accumulating smoldering smoke from drifting freely into the detection chambers of ion and light scattering detectors.

Extensive shielding also makes today's detectors difficult to silence and reset in the case of false alarms, such as from smoky cooking. Less shielding would allow for rapid silencing and resetting of an alarm, such as by a quick puff or two of breath. It is important to minimize the difficulty of clearing false alarms because difficulty leads to frustration and possible disabling by the consumer, and a disabled smoke detector is worse than no detector at all. An alarm that can be silenced quickly will reduce the nuisance factor of false alarms and also support the consumer's feeling of quality and confidence that the detector actually responds appropriately.

Underwriters Laboratories, Inc. (UL) tests smoke detectors on their response times at various levels of visual obscuration by smoke as measured in percent of obscuration per foot of path length. The UL tests measure detector performance for two categories of fire: flaming and smoldering. Typical smoke alarms detect a fast flaming fire within three (3) minutes or less and detect a slow smoldering fire within 20-60 minutes or less.

### SUMMARY OF THE INVENTION

Consumers urgently need smoke detectors that are more sensitive by design to the unique characteristics of a smoldering fire. At the same time, the methodology must not reduce a detector's capacity to detect flaming fires. To detect smoldering fires, a detector should not depend on the presence of turbulent, steam producing conditions to initiate a smoke alarm, nor should the detector be susceptible to frequent false alarms.

Smoldering fires build very slowly, typically over tens of minutes, so that the increase in the smoke obscuration level is slow and relatively steady. An important characteristic of a smoldering fire is this unique signature—a long upward increase in obscuration with no decreases.

The present invention provides a method to achieve rapid detection of a slowly accumulating smoke. The invention is described with reference to an optical obscuration-based system, but could alternatively be applied to non-obscuration systems as well.

One implementation of the present invention uses a simple, whole number counting register that provides a “Ramp Count”. In this implementation, each time the detector registers an increase in obscuration level over a prior sample, the Ramp Count is increased by one. When the detector registers a decreased obscuration level from a previous sample, the Ramp Count is reset to zero. This resetting of the counter is a ‘reversal event’ that nullifies any potential ramp confirmation up to that point in time. If there is no change in signal between samples, the Ramp Count is left unchanged. In a detector using a photo-electric (PE) optical obscuration system, for example, an increase in obscuration level corresponds to a decrease in a detected light signal, and a decrease in obscuration level corresponds to an increase in the detected light signal.

This Ramp Count method establishes a trend that will track any accumulating smoke that increases the obscuration level. Random noise produces a regular, steady stream of minor signal deviations, half of which are signal increases (obscuration decreases) that will serve to automatically reset the Ramp Count to zero on a routine basis. Since any increase in the detected light signal resets the Ramp Count, it is impossible for any long sequence of steadily decreasing detected light signal values (obscuration increases) to occur randomly. Such inherent, random noise is therefore employed for the useful purpose of resetting the Ramp Count and ending any prolonged trend of steady detected light signal decreases that do not result from an actual fire.

Disturbances that typically cause false alarms have a volatile nature that distinguishes them from the smoke accumulation from smoldering fires. The natural effect of such disturbances is to produce ups and downs in the detected light signal. The present invention employs this volatile nature of false alarm disturbances to prevent any long streak of spurious decreasing signal samples from building the ramp count. In this way, the Ramp Count method is able to routinely exclude any disturbance that is not a smoldering fire because volatile (i.e., non-monotonic) signature sequences are excluded. At the same time, the Ramp Count remains highly vigilant in detecting and confirming any steady sequence of slowly increasing obscuration levels caused by a smoldering fire. As such, the detector is poised to respond to the very first episode in which an Obscuration Level Alarm Threshold has been crossed while at the same time avoiding false alarms.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a layout diagram of a sample circuit board for a smoke sensing unit according to the present invention.

FIG. 2 is an idealized plot of increasing obscuration from smoldering smoke build-up.

FIG. 3 is an expanded scale graph of 25 samples illustrating random noise in an obscuration signal.

FIG. 4 is a graph in which the increasing obscuration from smoldering smoke build-up of FIG. 2 and the random noise of FIG. 3 are combined.

FIG. 5 is a system function overview flowchart showing basic operational flow of a smoke detection process according to the present invention and identifies subroutines detailed flowcharts shown in FIGS. 8-11.

FIG. 6 is a detailed flowchart of an initialization procedure on at power-up or a reset.

FIG. 7 is a detailed flowchart of a sampling process in which background noise contributions are removed and temperature compensation occurs.

FIG. 8 is a detailed flowchart of an alarm determination process in which ramp counts are kept and alarm conditions are evaluated.

FIG. 9 is a detailed flowchart of a housekeeping routine.

FIG. 10 is a graph in which the increasing obscuration from smoldering smoke build-up of FIG. 2 and the random noise of FIG. 3 are combined, but are represented with one-half the sampling rate of FIG. 4.

FIG. 11 is a graph comparing two systems with different path lengths that differ by a factor of three in relative signal response.

### DETAILED DESCRIPTION OF PREFERRED EMBODIMENTS

A preferred architecture for a single point smoke sensing unit employing the present invention is an obscuration-based smoke detection system or detector, generally like the one described in U.S. Pat. No. 7,075,445 of Booth et al. for Rapidly Responding, False Detection Immune Alarm Signal Producing Smoke Detector. However, methods of the invention described herein could be employed with any other means of detecting smoke.

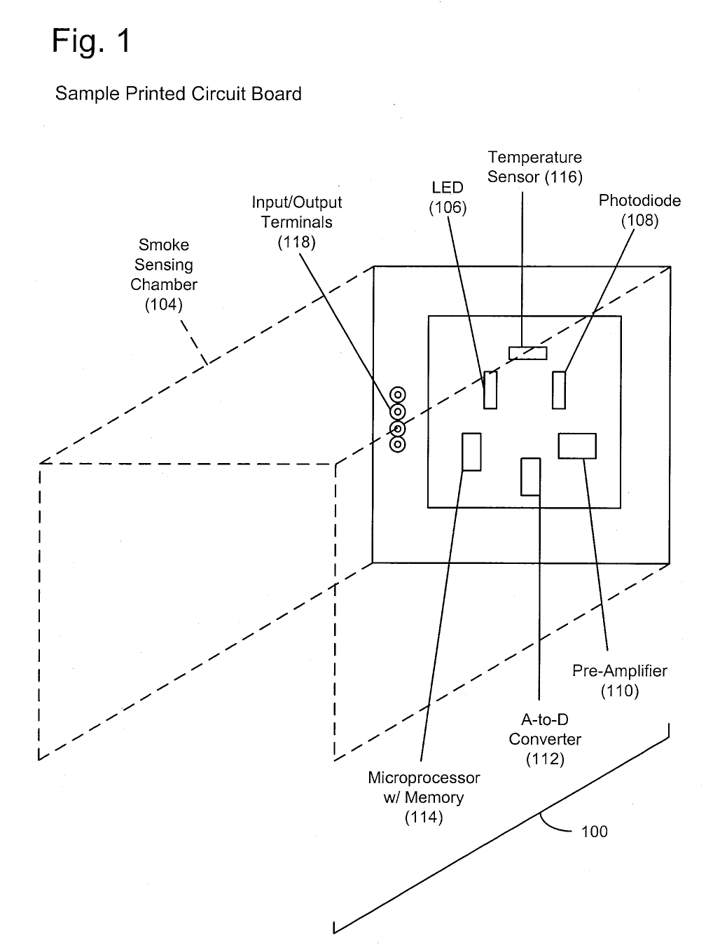

For purposes of illustration, FIG. 1 is a layout diagram of major circuit elements of a smoke detector smoke sensing unit 100 operating according to the present invention. A circuit board 102 attaches to an optical smoke sensing chamber 104 (shown in outline). As described in the Booth et al. patent, smoke detector smoke sensing unit 100 includes a light emitter or LED 106 in optical communication with a photodetector (e.g., photodiode) 108. A pre-amplifier 110 and an analog-to-digital converter ADC 112 form digital samples representing the obscuration of light between LED 106 and photodiode 108. A microprocessor and memory combination 114 executes stored software to process the digital obscuration samples to detect smoke according to the present invention. Microprocessor and memory combination 114 also communicates with a temperature sensor 116. Microprocessor and memory combination 114 communicates through input/output terminals 118 to provide alarm or fault signals to output devices (e.g., lights, horns, etc.), and to receive inputs (e.g., power, test controls, etc.). The illustrated circuit board components are a minimal implementation that senses smoke with minimized noise and cost.

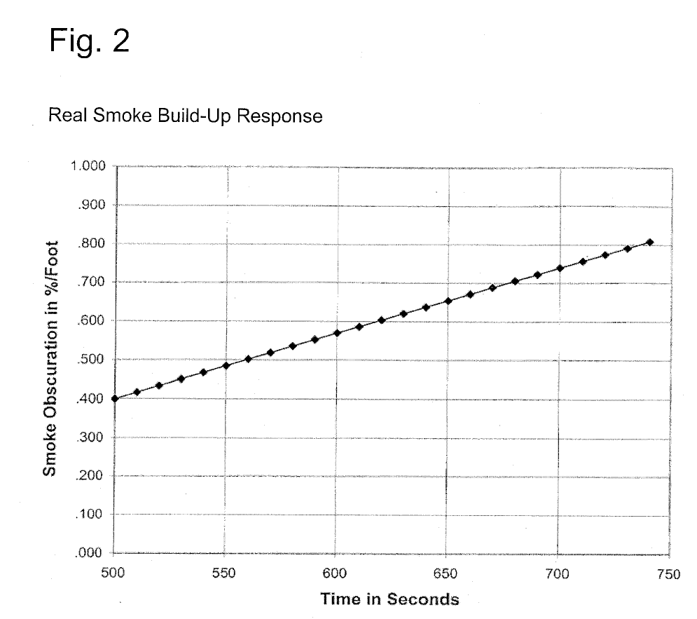

Detection of a slow, small, steady build-up of smoke, such as from a smoldering fire, depends on accurately measuring a representative signal for that accumulation above and apart from background noise sources. This measurement is commonly known as the signal-to-noise ratio (S/N Ratio or S/N). FIG. 2 is an idealized plot of increasing obscuration from smoldering smoke build-up. Note that this and following graphs are presented as obscuration levels and not light brightness signal levels.

The level of “obscuration” produced by smoke is expressed as a percentage decrease in visibility from clear conditions. On the scale for measuring obscuration, perfectly clear, “clean air” conditions produce a signal value of 100%. It is customary to invert the scale and use the signal decrease from clean air to represent the obscuration level. When the signal has been reduced to 99%, it has an obscuration level of 1%. When this occurs within a distance of one foot, it is called a 1%/foot obscuration level. Unlike other detectors, an obscuration measuring system does not rise from a zero-level response or have any background signal component to compensate for.

The term “signal” herein refers to the magnitude of the photo-electric signal derived from the detector readings. Typically clean air will be 100% of the useful range of counts, such as from of an analog-to-digital converter. As is known in the art, the useful range must be some portion of the whole analog-to-digital converter range, so that the clean air 100% level will correspond to a value such as 90% of the analog-to-digital converter range. The extra 10% is known as “headroom” and allows for some increases in the overall signal. Such increase can come from temperature changes, ambient effects, or other un-intended stimuli. When the signal reaches the top number of the ADC output it has been “clipped”, without knowing how much more signal there was above the top. When this happens the system no longer functions correctly. It is within this context that the following description refers to the clean air 100% level.

As smoke builds, the detected light signal count value goes down. When smoke (or other obscuration) clears, the response will automatically return to the original 100% value or an effective 100% value (i.e., a steady maximum value). References in this document made to % per foot of obscuration refer to the actual obscuration level, such as is measured during product certification testing by monitoring devices of Underwriters Laboratories, Inc.

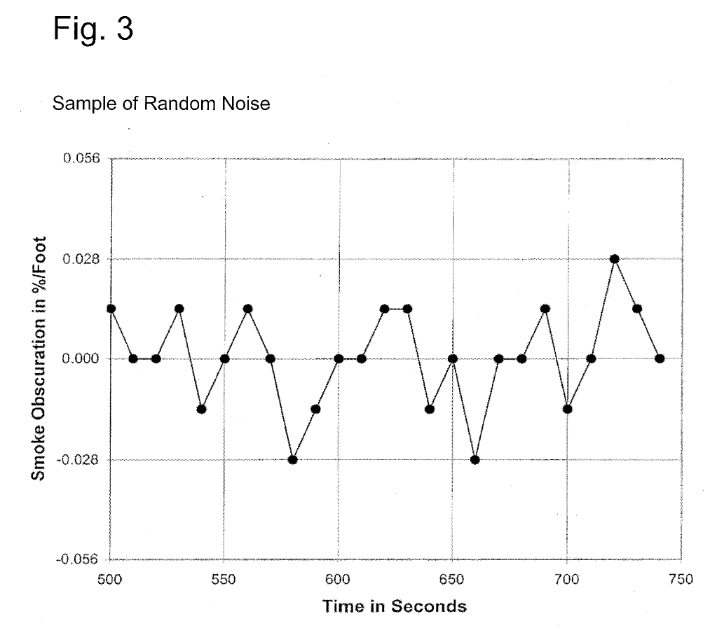

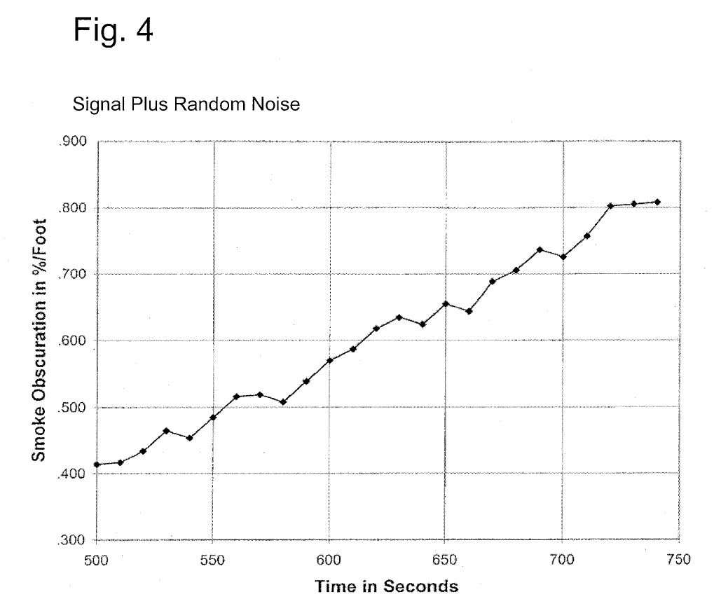

Any measurement system has inherent noise affecting its resolution and accuracy. FIG. 3 is an expanded scale graph of 25 samples illustrating an example of random noise in an obscuration signal. FIG. 4 is a graph in which the increasing obscuration from smoldering smoke build-up of FIG. 2 and the random noise of FIG. 3 are combined. The example of FIG. 4 includes 5 ramp reversal events due to the influence of random noise.

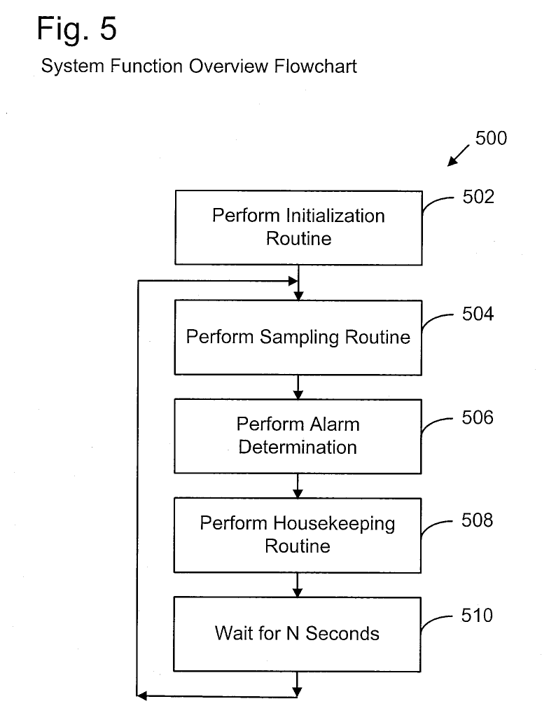

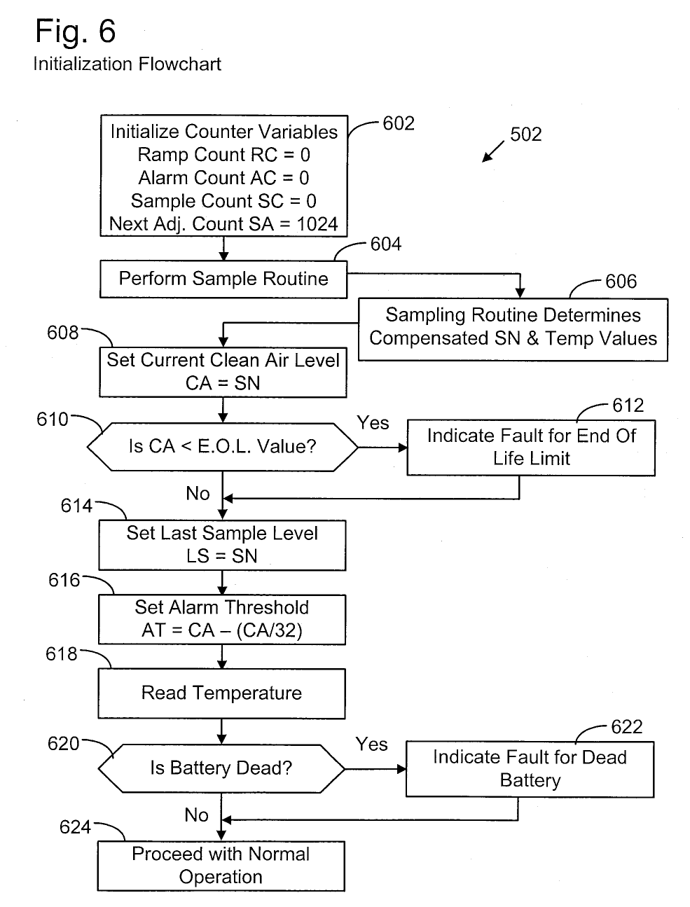

FIG. 5 is a system function overview flowchart showing basic operational flow of a smoke detection process 500 according to the present invention and identifies subroutines that are detailed flowcharts shown in FIGS. 6-9. Smoke detection process 500 represents a repeating single-loop master control procedure for the present invention.

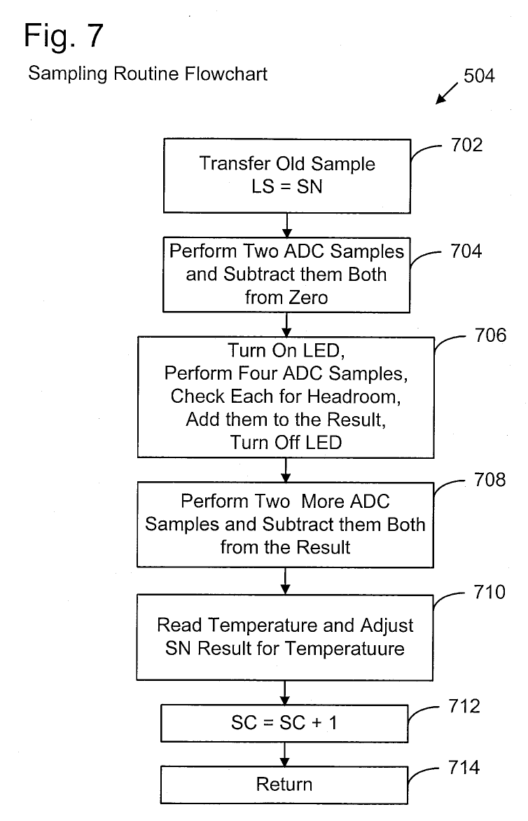

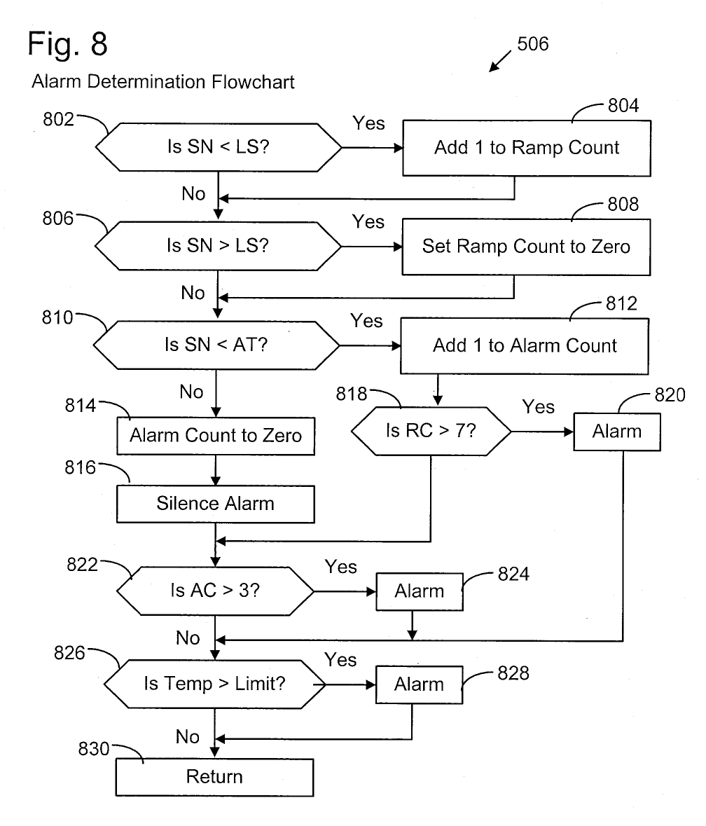

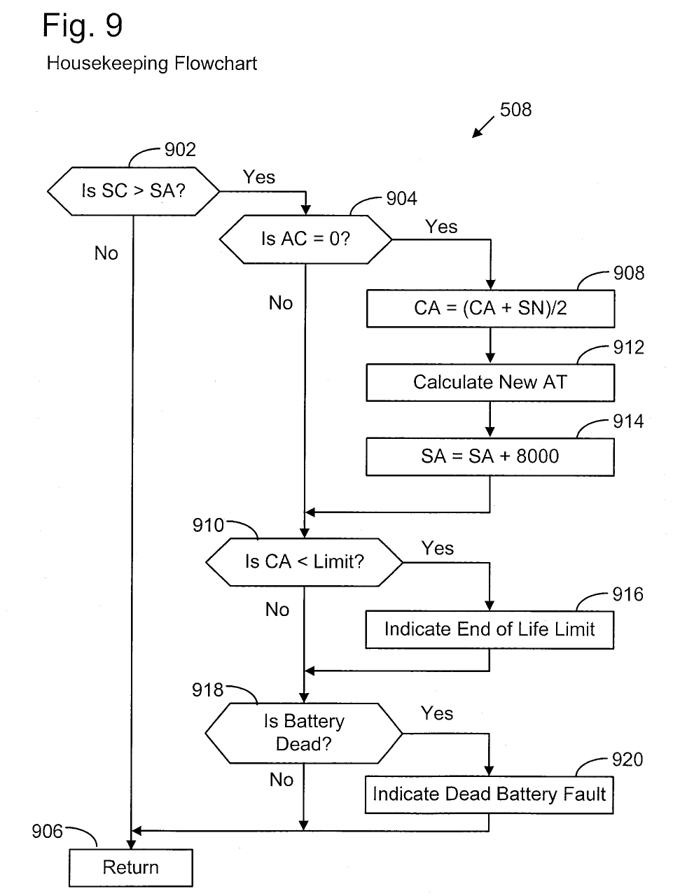

Smoke detection process 500 performs an initialization routine 502 (FIG. 6), such as at power-up or on a system reset. A sampling routine 504 (FIG. 7) removes background noise contributions and provides temperature compensation occurs during smoke detector operation. An alarm determination routine 506 (FIG. 8) keeps ramp counts and evaluates whether alarm conditions are met. A housekeeping routine 508 (FIG. 9) makes and schedules clean air adjustments, checks battery level, and tests the detector signal level against its end of life limit. Smoke detection process 500 includes a wait step 510, of a specified N-number of seconds, and then returns to sampling routine 504.

FIG. 6 is a flowchart of initialization routine 502, which is performed on a one-time whenever the system is powered back on. Initialization routine 502 sets initial variable values, checks for end of life and dead battery conditions, sets the alarm threshold level, and measures and sets initial clean air levels and schedules a clean air adjustment.

In step 602, initial variable values are set. For example, a ramp count RC, alarm count AC, and a sample count SC are each set to zero, and a next adjustment count SA is set to a value, such as 1024. In one implementation, ramp count RC corresponds to an integer value of samples in a non-decreasing ramp, such as from a ramp counting register. Alarm count AC corresponds to an integer value of alarm indications, such as from an alarm counting register. Sample count SC corresponds to an integer value of total samples since power-up, such as from a sample count register. Sample adjust SA corresponds to a next sample number at which a clean air adjustment is to be made.

In step 604, a sample routine 504 is performed to determine at step 606 compensated signal new SN and temperature values for the detector. In step 608, signal new SN signal level is set as a “clean air” signal level CA, based on samples obtained by sample routine 504, and the temperature value corresponds to a concurrent temperature reading from a temperature sensor.

In step 610, an end-of-life inquiry is made as to whether the clear air signal level CA is less than a predetermined end-of-life signal level EOL. The end-of-life signal level EOL indicates that the clear air signal level CA is so low that photo-detection capabilities of the detector have degraded beyond reliable detection capabilities. If the clear air signal level CA is less than the predetermined end-of-life signal level EOL, an end-of-life limit fault is indicated for the detector at step 612. Otherwise, step 610 proceeds to step 614.

In step 614, the last sample level LS is set to the signal new level SN. The last sample level LS corresponds to a detection value for the previous sample.

In step 616, an alarm threshold AT is set relative to the clean air level. In one implementation, alarm threshold AT is set as:

AT=CA−(CA/32).

Alarm threshold AT is a digital signal value of corresponding to a smoke threshold, as a percentage of CA.

In step 618, a temperature reading is determined at the temperature sensor in the detector.

In step 620, a battery dead inquiry is made as to whether the battery is below a selected threshold voltage. If the battery is below a selected threshold voltage, a battery dead fault is indicated at step 622. Otherwise step 620 proceeds to step 624.

In step 624, initialization is completed and operation proceeds to smoke detection process 500 at step 504.

FIG. 7 is a detailed flowchart of sampling process 504 in which background noise contributions are removed and temperature compensation occurs during smoke detector operation. Process 504 illustrates the operation of the sampling routine, which transfers the last sample reading, performs LED ON and LED OFF ADC samplings, takes a temperature reading, and increases the sample count register. An advantage of this sequence is that the LED only has to turn on once. Process 504 includes a headroom check to ensure accurate data sampling.

In step 702, the signal new value SN is designated or transferred as the last signal value LS.

In step 704, analog-to-digital converter ADC 112 is sampled (e.g., twice), and the two resulting digital sample values are subtracted from zero to obtain a partial signal new value SN′.

In step 706, the light emitter LED 106 is turned ON and the light therefrom is detected at detector 108 to obtain multiple (e.g., four) samples, which are digitized and added to the partial signal new value SN′. The LED 106 is then turned OFF. This sampling sequence can reduce noise arising from ambient light. Each signal sample response is essentially an ‘LED ON’ sample minus a ‘LED OFF’ sample to eliminate the noise contributions of ambient light. A common way to expand the total LSB counts is to count multiple times. Four complete sample cycles is a preferred number of repetitions—not too many or too few, taken in the following sequence:
1. Take two ‘LED off’ readings and subtract them from zero
2. Turn on the LED, then take and add four consecutive ‘LED on’ readings
3. Turn off LED, then take and subtract two more ‘LED off’ readings
   In this way, a 10-bit ADC yields 4000 counts and both sets of data samples (OFF and ON) are time-base averaged over the same center point in time. This method removes almost all flickering light effects when it can be achieved in less than 2 ms for all 8 samples.

If the system is also susceptible to ambient sources of signal that waste ADC range, then some additional ADC headroom range is required to prevent loss of data. All other forms of variation, such as temperature, lighting, EMI, dust, vibration, drift, wind, manufacturing variations, etc. should be accounted for in determining the optimum headroom to prevent data clipping.

In step 708, analog-to-digital converter ADC 112 is sampled (e.g., twice), and the two resulting digital sample values are subtracted from the partial signal new value SN′.

In step 710 the temperature is read and the partial signal new value SN′ is adjusted for temperature to provide a signal new SN. For example, as the light source temperature rises, its output goes down. When the temperature goes up, the SN is adjusted upwards to compensate for the lower light output. In this way, the changing temperature effect can be subtracted out from the smoke signal of interest.

In step 712, sample count SC is increased to SC+1.

Step 714 returns smoke detection process 500 at step 506.

FIG. 8 is a detailed flowchart of alarm determination process 506 in which ramp counts are kept and alarm conditions are evaluated, more specifically, the ramp and alarm counts are accumulated to determine if any alarm conditions are met.

In step 802, an inquiry is made whether the level of signal new SN is less than the level of last sample level LS. Signal new SN being less than last sample LS indicates that the signal level is decreasing and that light obscuration is increasing, possibly corresponding to increasing smoke. If the level of signal new SN is less than the level of last sample level LS, step 802 proceeds to step 804, where 1 is added to a ramp count RC. Otherwise, step 802 proceeds to step 806.

In step 806, an inquiry is made whether the level of signal new SN is greater than the level of last sample level LS. Signal new SN being greater than last sample LS indicates that the signal level is increasing and that light obscuration is decreasing, possibly corresponding to the absence of smoke build-up. If the level of signal new SN is greater than the level of last sample level LS, step 806 proceeds to step 808, where ramp count RC is set to zero. Otherwise, step 806 proceeds to step 810.

In step 810, an inquiry is made whether the level of signal new SN is less than the level of alarm threshold AT. Signal new SN being less than alarm threshold AT indicates that light obscuration is greater than a threshold level, possibly corresponding to smoke. If the level of signal new SN is less than the level of alarm threshold AT, step 810 proceeds to step 812, where 1 is added to an alarm count AC. Otherwise, step 810 proceeds to step 814 where alarm count AC is set to zero and step 816 where the alarm remains silent.

In step 818, an inquiry is made whether the level of ramp count RC is greater than a preselected value (e.g., 7). Ramp count RC being greater than the preselected value indicates that light obscuration has not decreased over the preselected number of sample periods and corresponds to an alarm condition. If ramp count RC is greater than the preselected value, step 818 proceeds to step 820 where an alarm is activated. Otherwise, step 818 proceeds top step 822.

In step 822, an inquiry is made whether alarm count AC is greater than a preselected value (e.g., 3). Alarm count AC being greater than the preselected value indicates that light obscuration has remained greater than the alarm threshold level AT over the preselected number of sample periods and corresponds to an alarm condition. If alarm count AC is greater than the preselected value, step 822 proceeds to step 824 where an alarm is activated. Otherwise, step 822 proceeds to step 826.

In step 826, an inquiry is made whether the temperature level TEMP is greater than a preselected limit value. Temperature level TEMP being greater than the preselected value indicates that the temperature at the detector is greater than the temperature limit and corresponds to an alarm condition. If temperature level TEMP is greater than the preselected limit value, step 826 proceeds to step 828 where an alarm is activated. Otherwise, step 826 proceeds to step 830 to smoke detection process 500 at step 508.

FIG. 9 is a detailed flowchart of housekeeping routine 508, which makes and schedules clean air adjustments, checks battery level, and tests the detector signal level against its end of life limit. Housekeeping routine 508 manages long-term system adjustments, using a counter to determine when to act, such as at every 8000 samples (e.g., about once daily at a sample rate of one sample every 10 seconds).

In step 902, an inquiry is made whether sample count SC is greater than sample adjust SA. Sample count SC being greater than sample adjust SA indicates that a sufficient number of samples have been taken to perform a clean air adjustment. If sample count SC is greater than sample adjust SA, step 902 proceeds to step 904. Otherwise, step 902 proceeds to step 906 to return smoke detection process 500 at step 510.

In step 906, an inquiry is made whether alarm count AC equals zero. Alarm count AC equaling zero indicates that no samples have had signal now levels SN that exceed the alarm threshold. If alarm count AC equals zero, step 906 proceeds to step 908. Otherwise, step 906 proceeds to step 910.

In step 908, clean air value CA is reset relative to the signal new SN:

CA=(CA+SN)/2

This resetting of clean air CA provides a value that corresponds to the updated conditions of an aging smoke detector. As the optics slowly collect dust and the light source degrades, so too does the signal value of clean air. This requires a correspondingly lower alarm threshold level as well.

In step 912, a new alarm threshold AT is calculated based upon the reset value of clean air CA. As described at step 614, alarm threshold AT is set relative to the clean air level such that:

AT=CA−(CA/32).

In step 914, the sample adjust SA is set to a new value to indicate when then system is to be adjusted again by adding a preselected value (e.g., 8000) to the sample adjust SA, as indicated by:

SA=SA+8000

In step 910, an inquiry is made whether the clean air value CA is below a predetermined end-of-life limit indicating that the detector has been too degraded to function accurately. If the clean air value CA is below the predetermined end-of-life limit, step 910 proceeds to step 916 where an end-of-life fault is generated with a corresponding indication to a user. Otherwise, step 910 proceeds to strep 918.

In step 918, an inquiry is made whether the battery powering the detector is dead, such as by determining if the battery voltage is below a predetermined limit. If the battery powering the detector is dead, step 918 proceeds to step 920 where a battery dead fault is generated with a corresponding indication for the user. Otherwise, step 918 proceeds to step 922 to return smoke detection process 500 at step 510.

During detection, a decreasing signal value is required on each and every successive sample in order to establish and confirm a slowly ramping smoke obscuration level. Even one random noise-related signal increase could reset the Ramp Count even though the real smoke level is still increasing. The absence of these ‘reversal events’ provides increasing confidence that a real smoldering fire is occurring.

As described herein, “noise” is the sum of all noise sources, measured in Least Significant Bits (LSBs) and represented as the standard deviation of signal uncertainty when the detector is in clean air. An efficient and simple way to measure noise is to record many data samples and perform a simple standard deviation calculation using the samples. For example, readings that deviated by +3 or −3 LSB from the average noise value in roughly every 50th sample would produce a standard deviation noise level of about +/−1 LSB. When the standard deviation of the noise is much smaller than 1 LSB, there is little deviation from sample-to-sample, and rarely more than one LSB of change for any sequential pair of samples. As the standard deviation size approaches 1 LSB, a greater number of sequential pairs differ than show repeated values.

In a genuine smoldering event the product of the time period between samples and the average signal rate of change per unit of time (LSB/sample period) needs to exceed the size of the random unfavorable noise that could occur. For example, if the average signal increase is 2 LSB per sample period, and the noise level standard deviation is only 1 LSB, there is about a 50/50 chance the Ramp Count will be reset before reaching eight—an exemplary Ramp Count Alarm Threshold. By the time the signal increase rate reaches 2.5 LSB per sample period, the chance that noise would reverse a ramp count of eight from noise is less than 10%.

Accordingly, there is a greater than 90% probability against a false reversal event during any period in which the Ramp Count reaches eight. This should be the minimum allowable probability, since there is still a significant chance that during eight successive sample periods, one may contain a reversal. Therefore, using the representative condition of 1 LSB=1 S.D. of noise, the rate of signal change over a sampling time period needs to be greater than 2.5 S.D. of noise.

How far the Ramp Count needs to climb before an alarm is triggered is another consideration. Requiring a Ramp Count Trigger condition of just two or three to trigger an alarm would result in far too many false alarms, as illustrated by the noise variations in the graph of FIG. 3.

Requiring a Ramp Count Alarm Threshold of six would almost completely eliminate false alarms. When this number reaches eight, there is no likelihood for this type of false alarm to occur randomly. The luxury of high ramp count requirement comes at the cost of S/N, since a higher count threshold requires proportionately more S/N. Requiring at least eight decreasing sequential samples means there must be at least eight reliably resolvable signal levels between clean air and alarm threshold to accomplish this task. Or put another way, within the sample-to-sample time period, there needs to be at least 3 S.D. of noise worth of change in signal.

To demonstrate this vulnerability, consider a very slowly smoldering fire that takes 60 minutes to achieve a 1%/foot UL obscuration level. In such a case, a one-foot path length signal is only changing by 1%/hour. This is equivalent to only a 0.006% change per sample, assuming one sample every 10 seconds, and requires a 0.002% single-S.D. noise level requirement. Using the faster rate of smoldering build-up that UL specifies for its testing (reaching 1% in 30 minutes) still requires a 0.012% change per sample and a 0.004% noise level.

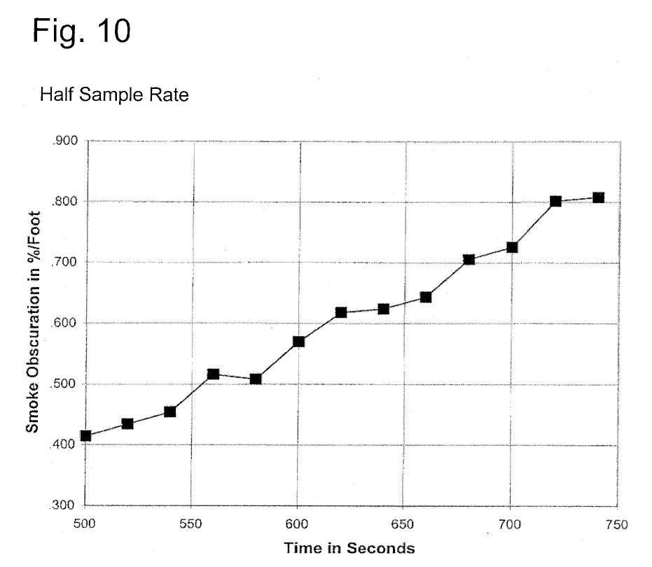

FIG. 10 is a graph in which the increasing obscuration from smoldering smoke build-up of FIG. 2 and the random noise of FIG. 3 are combined, but are represented with one-half the sampling rate of FIG. 4. By halving the sampling rate, the average change in the obscuration level from sample-to-sample doubles. In this example, the ramp reversal event rate is reduced by 80% from five events to only one.

A further penalty of high Ramp Count Alarm Threshold is speed of response. If the system took a sample every 10 seconds, a period of 80 seconds would elapse while the device accumulated an 8-sample ramp. If an alarm took 80 seconds to sound during a fast flaming fire, it would be too slow. The detector must include a second methodology to trigger the alarm in the case of rapid smoke accumulation to ensure a response within 60 seconds or less.

Since Ramp Count can be reset even when alarm level obscuration is present, it might never achieve the conditions needed for alarm. The alarm count AC provides a second alarm trigger to protect against any kind of fire that does not produce a gradual smoke accumulation, thereby providing an alternative non-smoldering smoke response. The Alarm Count permits a faster response than the Ramp Count method, which requires a relatively long sequence of successive samples with decreasing optical signal (i.e., increasing smoke level). As described above, the alarm count AC is increased by one whenever the signal now level SN drops below an Obscuration Level Alarm Threshold and is reset to zero if the signal ever rises back above this threshold.

By requiring the Alarm Count to accumulate to a value larger than its Alarm Count Alarm Threshold before the alarm is triggered, an effective waiting period is established to reduce false alarms without making the system unreasonably slow. For instance, at a six per minute sampling rate with a Alarm Count Alarm Threshold of more than 3, it would take up to 40 seconds (4-samples) for a fast fire to activate the alarm once the smoke reaches the detector. By adjusting the criteria for Alarm Count it is easy to adjust for the right balance of speed vs. false alarm nuisance. One embodiment could even allow the consumer to adjust the Alarm Count Alarm Threshold required for triggering the alarm so they can slow the speed of smoke detection in favor of avoiding false alarms. This would achieve the optimum balance of speed versus false alarm sensitivity.

Accordingly, this implementation would trigger a smoke alarm under two separate conditions:
1. Ramp Count becomes greater than the Ramp Count Alarm Threshold and the last sample goes beyond the Obscuration Level Alarm Threshold, or;
2. Alarm Count exceeds the Alarm Count Alarm Threshold.

To facilitate the detection of minor changes in the signal at every step or sample, detector performance and characteristics should be optimized.

### Preferred Path Length

The preferred optical path length should be substantially greater than one foot to maximize the available S/N ratio. It is possible and very desirable to achieve in excess of 30 inches of light path length within the confines of a reasonable single-point detector size using a multi-path optical system.

A preferred small physical size of a single point smoke detector tends to limit the light path length that can be fit inside the detection chamber. For example, if a three inch (¼ foot) light path system is used inside the detector, and the alarm triggers at a 2% per foot obscuration level, the real signal size change is only 0.5% (2×¼) because of the necessary downscaling to fit the detection chamber into the limited space of the smoke detector. This downscaling is a disadvantage. For example, if clean air produces 1000 counts on the scale, the smoke obscuration level sufficient to trigger the alarm occurs at 995 counts, only 5 away from 1000. Five increments is an insufficient range to develop an effective long-term ramp history. Either more signal response is needed, or the scale must be adjusted to produce a greater resolution above the noise.

One manner for expanding the scale and thereby increasing the effective signal response is described in U.S. Pat. No. 7,075,445 of Booth et al. The '445 patent uses opposing mirrors to fold a long smoke sensing path length into a very small size. More path length means more relative signal size for the same obscuration level per foot without significantly increasing the system noise. It provides a S/N gain. The '445 patent also describes the use of shorter-than-IR wavelengths and optical gain principles to enhance usable signal counts above the noise.

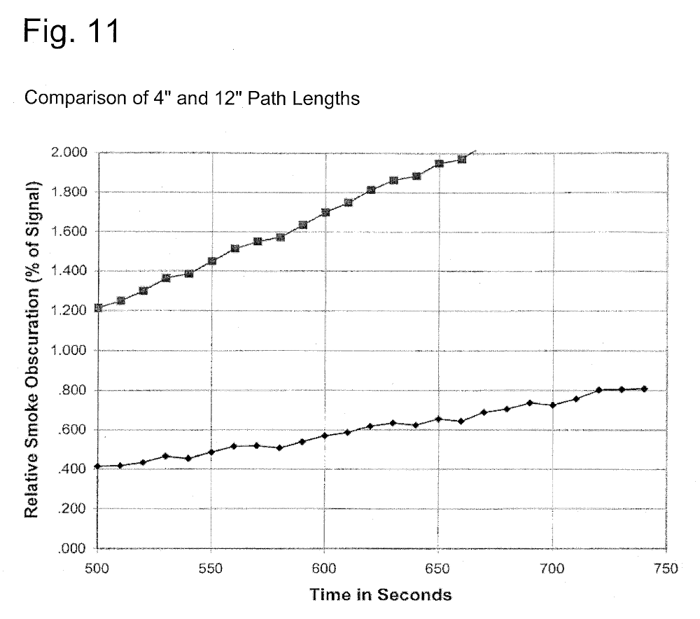

FIG. 11 is a graph comparing two systems with different path lengths that differ by a factor of three in relative signal response. The figure emphasizes the difference in performance between the two systems. The system with longer path length (e.g., 12 inches) has the high rate of signal change relative to the change in real obscuration level shows no ramp reversal events at all. The system with the shorter path length (e.g. 4 inches) a low rate of signal change has five reversal events in the same obscuration conditions.

### Applying Optical Gain

Modern Light Emitting Diodes are very efficient light sources for smoke detectors. By using optical components such as lenses or reflectors in conjunction with LEDs, the light can be more efficiently introduced and collected by an obscuration-based system. By delivering as much light to the detector as possible, the useful signal over the noise is maximized. An added benefit of this efficiency in collecting light is that less battery power will be needed to drive the LED, and battery life will be prolonged.

### Particle Size & Light Color

The particle size commonly found in smoke is in the 100 to 1000 nanometer (nm) size range. Photoelectric (PE) detectors typically use long wavelength light such as infrared (>700 nm), which makes them poor at detecting small smoke particles. This is because the smaller particles do not scatter the longer light waves enough to deflect them all the way into the detector. Recall that the amount of light scattered off the smoke is the key physical effect needed to produce a signal in a PE detector, and this is the main problem with conventional detectors. Smaller wavelength light, such as blue light at <500 nm produces a much higher percentage of change in the signal level than longer-wavelength infrared light under the same conditions. In fact, a 470 nm LED produces about five times the signal change of the IR beam when used in an obscuration system. There is no loss of sensitivity by shortening the wavelength to detect the smaller particles. Large smoke particles obscure short wavelength light without limit.

### Determining the Design Requirement for S/N

A benchmark for establishing the necessary signal size above noise has been described and is useful in guiding design considerations. A specific goal is to create the ability to determine and confirm a real and ever-increasing smoke level pattern without allowing any random noise reversal events to end a ramp counting streak produced by a real smoldering fire.

A characteristic of real-world smoldering fires is that they can develop so slowly that there is almost no change at all from sample-to-sample. Consider a fire that takes 10 minutes to climb from 0.5% per foot to 1.5% per foot (0.1% per foot per minute). On average over any 10 second period there will be only a 0.018% rise in obscuration level. If a sample is taken every 10 seconds, but the noise keeps adding and subtracting randomly, the system must be able to accurately resolve 0.01% obscuration level change at the very least to keep these random noises from resetting a Ramp Count streak.

To find the minimum required useful LSB needed, it is useful to start with the. magnitude of the background noise. The minimum signal size needed to detect and record a complete ramp sequence within the signal range from clean air to alarm threshold is expressed as follows:

Clean Air—Alarm Threshold=8 samples×2.5 S.D./sample=20 S.D. units of change

In a case involving 1 LSB per SD, it would take a minimum system resolution of 20 LSB of signal change from clean air to alarm threshold in order to be 95% confident of an Alarm Count result of eight.

Therefore a three-inch path length system with a 2% per foot (UL) alarm threshold needs 0.5% of its useful ADC (analog-to-digital converter) range to equal at least 20 LSB. Dividing the 0.5% threshold by 20 gives the maximum allowable noise size of 0.025% per LSB. The minimum necessary resolvable LSB's needed to achieve this result can be stated as follows:

Minimum Resolvable S/N ratio=1 S.D./0.025%=4,000 S.D. units

When 1 LSB=1 S.D. of noise, the useful ADC range must be larger than 4,000 LSB (12 bits). If the system is not quiet enough to actually achieve single LSB noise levels, then the required total number of LSB goes up proportionately.

Aging is a special concern. If end of life occurs with a greatly reduced signal response, but noise contributions remain unchanged, then even more LSB range is needed when new. If aging means half the signal is left, then at least twice as many LSB counts (8,000) are needed when new to be safe, plus headroom. Depending on ambient headroom needs, this simple system now needs at least 14 bits of total resolution to achieve these lofty specifications.

By shifting to blue light for a 5× response increase and substituting a 24″ path length for the 4″ example, the total useful LSB requirement could be as low as:

8,000/5/6=267 reliably resolvable S.D. noise units, or about 8 bits

Using this calculation procedure, it is easy to predict how a system design will perform.

FIG. 1 shows one embodiment of a dedicated circuit board attached to an optical smoke sensing chamber. The illustrated circuit board components are a minimal implementation that senses smoke with minimized noise and cost. Because everything needed to run the system described in this disclosure is so simple, a smoke detector of the present invention needs no long-term, non-volatile unit-specific memory. End of life, alarm threshold, and other necessary values could be written in standard version of code and no other information about a particular system is required to produce these performance results.

Large cost savings are possible because a properly designed obscuration system of this invention does not need laborious calibration, either during use or in manufacture. Besides not needing any factory calibration, these systems can literally wake up at any time in their lifetimes and function accurately. A hardware based calibration solution like fusible gain resistors, would compensate for the manufacturing variability of components and would use nearly all the available ADC range. All of these features make this invention a high performance system that can be manufactured at very low cost.

In another embodiment a simple power reset could even be used to silence a false alarm. This would still work fine if the unit is powered up during a smoke or false alarm event since the clean air value will be adjusted back up to where it should be with the clean air adjustment feature.

As described with reference to step 706 of sampling routine 504 (FIG. 7), noise from ambient light can be reduced by timing of the ADC sampling in a particular pattern. If this sampling technique is used with a smoke detection system that is designed to achieve a 0.6% per foot (UL) alarm threshold with a 24 inch optical path length and a 430 nm LED, it will yield an alarm threshold shift of 3.6% of the 3500 (useful) counts, or 126 LSB. This sufficient to establish 8-sample ramp counts with plenty of margin to spare. Even if one S.D. of noise equals 2 LSB, it still represents a true system resolution of 0.01% per foot of UL monitor beam smoke using a 10-bit ADC. This is a large cost savings and enables easy implementation since maintaining background noise levels below 9-bit levels is quite easy.

A convenient aspect of the digital (i.e., binary) processing employed in the illustrated embodiment of the present invention is that signal change thresholds of 1.6 or 3.2% away from a number may be readily set by shifting the bits of the signal down by 6 and 5 digits, respectively. A compromise is readily achievable in the early design phase with so many variables to work with. Even compensation for the changing signal response as the system ages would be readily to achievable.

In one alternative embodiment, the Clean Air reading could be reset to any larger sample value at any time, since for many obscuration based systems, there is no way to artificially or accidentally get a result higher than the clean air result. If an old unit had its dust blown out, it might actually register a large jump in signal, and hence be very insensitive to smoke for a while until the housekeeping routine corrects things. In this case, a simple power cycle immediately resets the detector.

Another alternative embodiment includes a rapid sampling rate for testing the detector, such as by consumer activation of a “test” button. By increasing the sampling rate to 1 Hz or faster when a “test” button is pushed (for a specific period of time), a very quick detector response would be impressively different from existing products. Another way to provide fast response during a ‘test mode’ is by not requiring the ramp count and just triggering as soon as the alarm threshold is crossed.

As described above, an objective of this invention is to control background noise. Another manner of achieving this is by use of small and dedicated circuit board 102 (FIG. 1) at one end of the smoke-sensing chamber 104. By using a very small and dedicated PCB, the temperature response is maximized and all EMI influences are also minimized with short conductive traces. All this can be produced at a low cost. An advantage is that the detector could be 100% digital in its communication the input/output terminals, thereby providing maximum control over noise sources. Using a digital temperature sensor chip would be a good way to enable this. This implementation also provides a self-contained smoke sensing module as a sub-component of a complete smoke detector system.

It will be appreciated that other alternative implementations could also be employed. In one such alternative the system could adjust for response slope changes over time by compensation based on where the current system response is in relation to its original value. Another S/N ratio improvement is to use opaque materials at key design points such as:
The LED body—to avoid direct light leakage from LED to detector
The detector body—by the same argument, enclosing the detector to just see out its lens
The Printed Circuit Board should be dark to the light being used
A dividing wall should be molded directly into the optical smoke sensing chamber

Another S/N improvement is to use a narrow beam LED with its own lens like Liteon LTST-C930CBKT chip type SMT LED. Another improvement is to use a photodiode with integral lens too. It can be narrow beam for maximum gain.

In the implementation described above, this invention provides a triple technology solution for the task of detecting smoke. The three different technology solutions are:
Ramp History for fastest smoldering fire response without false alarms
Blue obscuration for the optimum response to real smoke of all colors and sizes
Thermal protection (temperature limit, with or without rate of rise)

A alternative advantage could include FFAR (Fast False Alarm Recovery). An advantage of an easily ventilated smoke detector would be the ease of clearing smoke or other airborne stimulus by blowing it right out. If the sampling rate were significantly increased when the alarm sounds, then merely blowing at it with clean air would silence it very quickly. The second best thing to true false alarm immunity is a quickly recovering design.

Another embodiment could employ a two-level threshold strategy. A very low threshold could be used for the smoldering 8-long ramp alarm while a more conventional higher threshold could help avoid false alarms with other sources, instead of slowing response by waiting with the Alarm Count method. This method might false alarm more often than existing products because its rapid ventilating qualities would allow every false alarm right in. However, the real smoke response is much faster too, so if false alarms were not a concern, this would be the fastest of all solutions.

In view of the many possible embodiments to which the principles of our invention may be applied, it should be recognized that the detailed embodiments are illustrative only and should not be taken as limiting the scope of our invention. Rather, the invention includes all such embodiments as may come within the scope and spirit of the following claims and equivalents thereto.

1. A smoke detection method, comprising:
detecting plural successive smoke level samples;
increasing a smoke detection ramp count for each successive smoke level sample that does not decrease from a previous one;
resetting the smoke detection ramp count whenever a smoke level sample decreases relative to a previous one; and
triggering a smoke detection alarm whenever the smoke detection ramp count exceeds a predetermined threshold.

2. The method of claim 1 further comprising:
determining whether a predetermined number of smoke level samples are greater than an alarm threshold; and
triggering a smoke detection alarm whenever the predetermined number of smoke level samples are greater than the alarm threshold.

3. The method of claim 2 further including:
automatically setting a clean air value corresponding to a no-smoke condition; and
automatically setting the alarm threshold as a predetermined proportional value of the clean air value.

4. The method of claim 1 further comprising:
detecting a temperature; and
triggering a smoke detection alarm whenever the temperature is greater than a predetermined temperature limit.

5. The method of claim 1 in which detecting the plural successive smoke sample levels includes detecting optical obscuration, whereby decreases in smoke level samples correspond to increases in optical obscuration and increases in smoke level samples correspond to decreases in optical obscuration.

6. The method of claim 5 in which detecting optical obscuration includes detection with a light emitter in both an ON state and an OFF state.

7. A smoke detection method, comprising:
ramp-counting non-decreasing smoke level samples for detecting smoldering fire conditions; and
counting obscuring smoke level samples for detecting other-than-smoldering fire conditions.

8. The method of claim 7 further comprising detecting whether a detector temperature is greater than a threshold temperature to provide a third fire detection mechanism.

9. The method of claim 7 in which ramp-counting non-decreasing smoke level samples includes increasing a smoke detection ramp count for each successive smoke level sample that does not decrease from a previous one and resetting the smoke detection ramp count whenever a smoke level sample decreases relative to a previous one.

10. The method of claim 7 in which counting obscuring smoke level samples includes determining whether a predetermined number of smoke level samples are greater than an alarm threshold.

11. The method of claim 7 further including:
automatically setting a clean air value corresponding to a no-smoke condition; and
automatically setting an alarm threshold as a predetermined proportional value of the clean air value for counting obscuring smoke level samples.
